(19) United States
(12) Patent Application Publication
(10) Pub. No.: US 2010/0241457 A1
(43) Pub. Date: Sep. 23, 2010

(54) NETWORK SERVER, CONTROL METHOD, AND MEDICAL NETWORK SYSTEM

(75) Inventor: Yuya KUDO, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/728,980

(22) Filed: Mar. 22, 2010

(30) Foreign Application Priority Data
Mar. 23, 2009 (JP) 2009-069676

(51) Int. Cl. G06Q 50/00; G06Q 10/00; G06F 17/30; G06F 15/16

(52) U.S. Cl. 705/3; 705/2; 707/802; 707/705; 709/203; 707/E17.005; 707/E17.044; 707/E17.107

(57) ABSTRACT

A medical network system includes a terminal device for generating ordering information of a medical examination inclusive of personal information of a body, to place an examination order. A server apparatus is positioned at a central hospital as diagnostic service provider for the examination, for receiving the ordering information. A network server is positioned separately from the central hospital. The network server includes an order processor for receiving the ordering information from the terminal device. A communication device transmits the ordering information received by the order processor to the server apparatus. An information generating device deletes the personal information from the ordering information after transmission thereof, and creates index information for specifying the terminal device, the central hospital related to the examination order, and the ordering information received by the server apparatus. A request processor receives a data request of information from the terminal device.

### BACKGROUND OF THE INVENTION

1. Field of the Invention

The present invention relates to a network server, control method, and medical network system. More particularly, the present invention relates to a network server, control method, and medical network system in which medical information including a patient's personal information can be handled at a low cost.

2. Description Related to the Prior Art

For total care of patients, a plurality of medical facilities are linked together in a geographical region. A central hospital as diagnostic service provider, which has highly precise medical instruments and the like, is requested by clinics as local medical facilities with a relatively small scale, for conducting a medical examination. A medical network system has been developed, in which orders for the medical examination can be placed online between the medical facilities in cooperation of a data center with which diagnostic service is provided.

The medical network system includes client terminal devices or local nodes, a server apparatus or hospital server, and a network server or central server or data center server. The terminal devices are installed in respectively the clinics for placing an order of the medical examination. The server apparatus is installed in the central hospital for receiving the order. The network server is installed in the data center and is connected by the network to the terminal devices of the clinics and the server apparatus. For ordering, each of the terminal devices of the clinics transmits ordering information of the medical examination to the network server, the ordering information including personal information of a patient, for example, name, birthday, street address and the like, and modality of the medical examination, for example, CT, MRI and the like.

Leakage of the personal information of the patient due to improper access must be prevented in the server apparatus. To this end, direct online access from unspecified external nodes is restricted. In compliance with the restricted access, the network server receives direct online access from the terminal device of the clinic, to transmit the ordering information from the terminal device to the server apparatus by networking. There is a case database of reservation or order management database or DB in connection with the server apparatus. The ordering information is stored by the server apparatus in the case database after reception from the terminal device of the clinic via the network server.

The network server transmits the ordering information received from the terminal device of the clinic to the server apparatus. Also, a center database of the data center is connected with the network server. The network server writes the ordering information from the terminal device of the clinic to the center database in order to notify the terminal device of a result of the examination or the current status of the examination orders in the central hospital. The network server, upon receiving the request for order tracking (reservation confirmation) of the examination order from the terminal device of the clinic, searches and retrieves the ordering information from the center database, and displays the ordering information on a display panel at the terminal device. The network server stores the ordering information inclusive of the personal information of the patient as well as the case database of the central hospital. See U.S. Pat. No. 2005/228,697 (corresponding to JP-A 2005-301434) and JP-A 2003-186997.

Management of the personal information has been legally controlled as recently strict standards or rules for public systems in which the personal information is handled. Medical information is specifically confidential information because inclusive of the personal information. The management of the medical information is further regulated than other types of the personal information by various governmental organizations. In the data center for the diagnostic service, the management of the personal information is maintained with a very high cost for the purpose of satisfying the requirements conditioned legally.

The medical information containing the personal information which the data center must manage includes information other than the ordering information. For example, there are examination reports of the medical examination after examination in the central hospital. It is impossible due to the restricted access for the terminal devices of the clinics to access the server apparatus directly online to retrieve the examination reports. The network server receives uploading of the examination reports from the server apparatus, and stores the examination reports in an examination database which can be accessed by the terminal devices of the clinics. The examination reports always contain the personal information of the patient. However, the expense required for information management will be higher according to an increase in the number of the types of the medical information containing the personal information to be managed.

### SUMMARY OF THE INVENTION

In view of the foregoing problems, an object of the present invention is to provide a network server, control method, and medical network system in which medical information including a patient's personal information can be handled at a low cost.

In order to achieve the above and other objects and advantages of this invention, a network server includes an order processor for receiving ordering information from a terminal device, the ordering information being adapted to placing an examination order of a medical examination and including personal information of a human body, content of the examination order, information of a diagnostic service provider for the examination, and information of the terminal device. A communication device transmits the ordering information received by the order processor to a server apparatus positioned with the diagnostic service provider specified according to the provider information. An information generating device creates index information from the ordering information, the index information specifying the terminal device, the diagnostic service provider and the ordering information, wherein the personal information is unrecognizable in the index information for anonymity. A request processor receives a data request from the terminal device for case specific information of the examination of the examination order. A request unit transmits a send request for outputting the case specific information to the server apparatus according to the index information upon receiving the data request in the request processor. A transfer processor transmits the case specific information output by the server apparatus according to the send request to the terminal device, and deletes the case specific information after transmission thereof.

The case specific information, before the examination, is the content of the examination order, and after the examination, is a result of the examination associated with the personal information.

Furthermore, there is a first database. A database access device writes the ordering information from the order processor to the first database in association with a first reservation ID for identifying the ordering information, and deletes the ordering information from the first database after the index information is produced from the ordering information in the first database.

The index information further includes the first reservation ID.

The communication device additionally assigns the index information with a second reservation ID for identifying the ordering information in the server apparatus upon receiving the second reservation ID from the server apparatus. The second reservation ID is created by the server apparatus, and stored in a second database of the server apparatus in association with the case specific information.

The request unit retrieves the index information from the first database in association with the examination according to the data request, specifies the server apparatus according to the index information, and transmits the second reservation ID to the server apparatus.

The transfer processor converts the case specific information in a format for display at the terminal device, and transmits the converted case specific information to the terminal device.

The transfer processor further converts at least partial information included in the index information, and transmits the converted partial information to the terminal device.

Furthermore, a database stores event information of an examination order of the examination for each one of calendar dates. A controller updates the database when the server apparatus is updated in relation to the examination order, and updates the server apparatus when the database is updated, to make coincidence of the event information being stored between the server apparatus and the database. The terminal device includes a display panel for displaying presence or absence of the event information according to the dates. An input interface inputs the event information at an available one of the dates without an examination order, to cause the order processor to write the event information to the database.

Also, a medical network system is provided, and includes plural terminal devices, positioned locally, for generating ordering information of an examination order of a medical examination inclusive of personal information of a human body. A server apparatus is positioned with a diagnostic service provider for the examination, for receiving the ordering information. A network server is connected online with the plural terminal devices and the server apparatus. The network server includes an order processor for receiving the ordering information from each one of the terminal devices. A communication device transmits the ordering information received by the order processor to a server apparatus specified according to the provider information. An information generating device creates index information from the ordering information, the index information specifying the terminal device, the diagnostic service provider and the ordering information, wherein the personal information is unrecognizable in the index information for anonymity. A request processor receives a data request from the terminal device for case specific information of the examination of the examination order. A request unit transmits a send request for outputting the case specific information to the server apparatus according to the index information upon receiving the data request in the request processor. A transfer processor transmits the case specific information output by the server apparatus according to the send request to the terminal device, and deleting the case specific information after transmission thereof.

Also, a control method for a network server is provided, and includes a step of receiving ordering information from a terminal device, the ordering information being adapted to placing an examination order of a medical examination and including personal information of a human body, content of the examination order, information of a diagnostic service provider for the examination, and information of the terminal device. The ordering information is transmitted to a server apparatus positioned with the diagnostic service provider specified according to the provider information. Index information is created from the ordering information, the index information specifying the terminal device, the diagnostic service provider and the ordering information, wherein the personal information is unrecognizable in the index information for anonymity. When a data request is received from the terminal device for case specific information of the examination of the examination order, a send request for outputting the case specific information is transmitted to the server apparatus according to the index information. The case specific information output by the server apparatus according to the send request is transmitted to the terminal device, and the case specific information is deleted after transmission thereof.

Also, a network server is provided, and includes an order processor for receiving ordering information from a terminal device, and transmitting the ordering information to a server apparatus positioned at a diagnostic service provider specified by the terminal device, the ordering information including personal information of a body and being adapted for placing an examination order of a medical examination. An information generating device deletes the personal information from the ordering information after transmission thereof, and creates index information for specifying the terminal device, the diagnostic service provider related to the examination order, and the ordering information received by the server apparatus. An order tracking device receives a data request from the terminal device for case specific information of the examination of the examination order, and transmits a send request for outputting the case specific information to the server apparatus according to the index information. A transfer processor transmits the case specific information output by the server apparatus according to the send request to the terminal device, and deletes the case specific information after transmission thereof.

Furthermore, a communication device transmits the ordering information and the send request to the server apparatus.

Consequently, a patient's personal information can be handled at a low cost, because the network server can operate effectively between the server apparatus and the terminal device for filing of ordering information.

### BRIEF DESCRIPTION OF THE DRAWINGS

The above objects and advantages of the present invention will become more apparent from the following detailed description when read in connection with the accompanying drawings, in which:

FIG. 1 is a block diagram illustrating a medical network system;

FIG. 2 is a block diagram illustrating data stored in a center database;

FIG. 3 is a block diagram illustrating data stored in a patient database and case database;

FIG. 4 is a chart illustrating relationships between a patient ID, reservation ID, and ordering information;

FIG. 5 is a block diagram illustrating terminal devices, a server apparatus and a network server;

FIG. 6 is a block diagram illustrating blocks in CPUs of the server apparatus and the network server;

FIG. 7 is a block diagram illustrating relevant blocks for order processing of an examination order;

FIG. 8 is a block diagram illustrating relevant blocks for retrieving the ordering information;

FIG. 9 is a block diagram illustrating relevant blocks for retrieving an examination report;

FIG. 10 is an explanatory view in a plan illustrating a menu window for the order processing;

FIG. 11 is an explanatory view in a plan illustrating an order window for inputting the ordering information;

FIG. 12 is an explanatory view in a plan illustrating the menu window for the order processing after outputting an examination report;

FIG. 13 is an explanatory view in a plan illustrating an order tracking window to display content of the examination order;

FIG. 14 is an explanatory view in a plan illustrating a report window to display the examination report;

FIG. 15 is a timing chart illustrating a sequence in the medical network system upon receiving a data request of information from a terminal device.

### DETAILED DESCRIPTION OF THE PREFERRED EMBODIMENT(S) OF THE PRESENT INVENTION

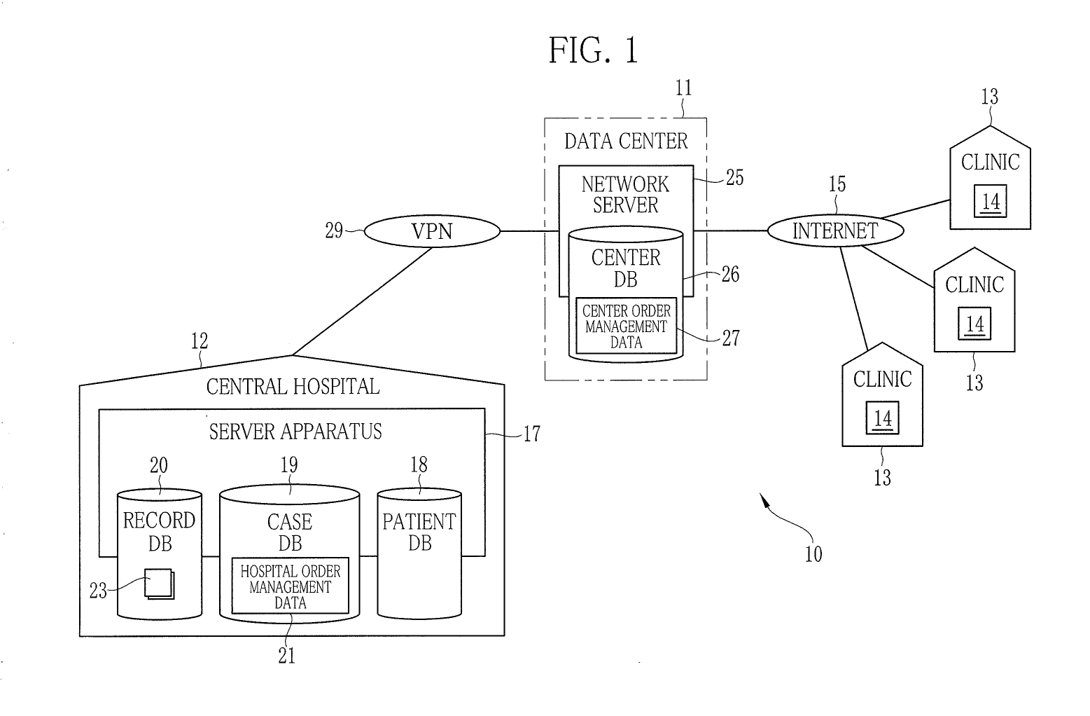

In FIG. 1, a medical network system 10 in a client/server architecture includes a network server and a plurality of terminal devices online therewith by a communication network. A data center 11 or network data center or data center system has the network server. Local clinics have respectively terminal devices installed therein. The medical network system 10 processes an order for medical examination online, and also causes retrieval of case specific information of the examination, for example a content of the examination order by order tracking, and examination data. The data center 11 is connected with plural terminal devices, and operates for services of receiving orders of examination, and for services of order tracking (reservation conformation) by retrieving case specific information of the examination.

In the medical network system 10, there is a central hospital 12 as diagnostic service provider, with which clinics 13 as local medical facilities are associated online. The central hospital 12 has various precise apparatuses or instruments for medical examination, such as CT (computed tomography) apparatus, MRI (magnetic resonance imaging) apparatus and the like. The central hospital 12 has a large scale among the networked constituents, and provides a diagnostic service upon receiving an examination order from the clinic 13.

The clinics 13 are so small that there are no examination apparatuses for precise examination. Client terminal devices 14 or local nodes are installed in respectively the clinics 13. Each of the terminal devices 14 is a personal computer in which a web browser is installed. The terminal devices 14 generate ordering information including personal information of a patient, and send the ordering information to the data center 11. The terminal devices 14 place an examination order of the examination in the central hospital 12 by use of the Internet 15 with the data center 11. Also, the terminal devices 14 access a network server 25 or central server or data center server in the data center 11, and send a data request of case specific information of the examination.

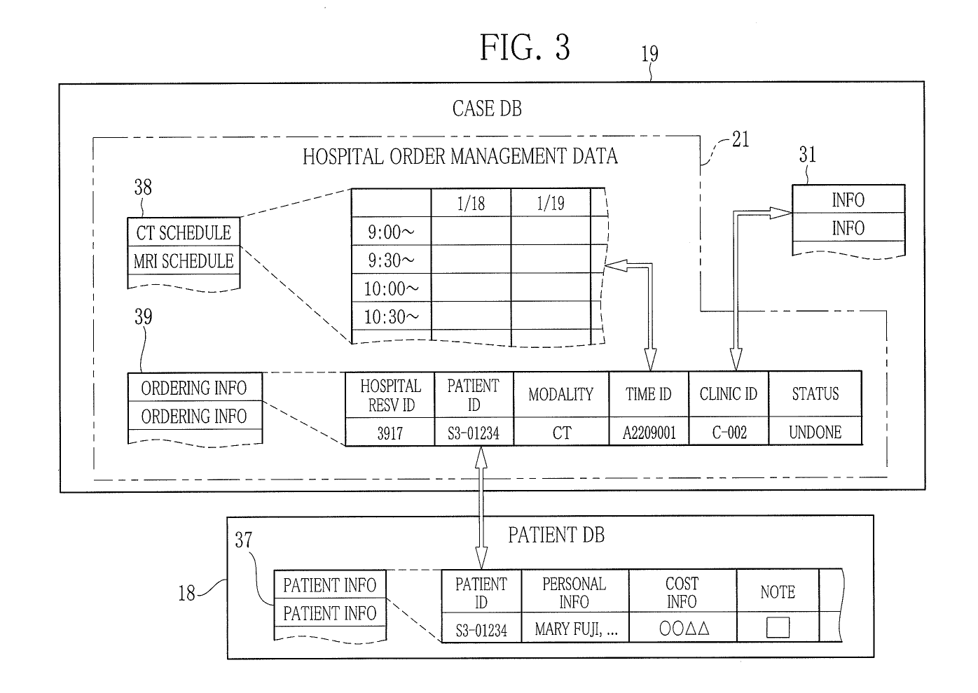

A computer system of the central hospital 12 includes a server apparatus 17 or hospital server, a patient database 18 or DB, a case database 19 of reservation or order management database or DB, and a record database 20 or DB for examination reports. The patient database 18 stores patient information of FIG. 3 in the central hospital 12. Hospital order management data 21 of FIG. 3 are stored in the case database 19, and are information of a current status of examination orders and the like. Information of examination reports 23 as case specific information is stored in the record database 20 among examination data, which also include diagnostic images (not shown) of a patient's body and the like.

An internal network (not shown) or intranet is installed in the central hospital 12. The server apparatus 17 is connected by the internal network to the patient database 18, the case database 19 and the record database 20, and various examination apparatuses (not shown) in hospital departments, and a document processing device. The server apparatus 17 includes plural components, which are a communication server, reservation management server, order management server, database server and the like. The communication server receives and transmits various data to or from the data center 11.

The reservation management server is a constituent in the Hospital Information System or HIS, receives examination orders from the clinics 13 through the data center 11, and manages the schedule of examinations. The reservation management server assigns the ordering information from the data center 11 with a hospital reservation ID as second reservation ID of FIG. 3, and then writes the ordering information additionally with the hospital order management data 21 of FIG. 3 to update the current status. The hospital reservation ID is used to specify the particular ordering information received by the server apparatus 17, and usable only in the central hospital 12. The reservation management server places an examination order to the order management server according to the received ordering information.

The order management server is installed in each of examination departments in the hospital, receives information of the examination order transmitted by the reservation management server, and stores and manages the examination order. An example of examination department is a radiology department. The order management server constitutes the Radiology Information System or RIS.

The database server writes diagnostic images formed in the examination and the examination reports 23 to the record database 20, the examination reports 23 being drafted by a document processing device. Examples of the database server are a PACS (Picture Archiving and Communication System) server, report server and the like.

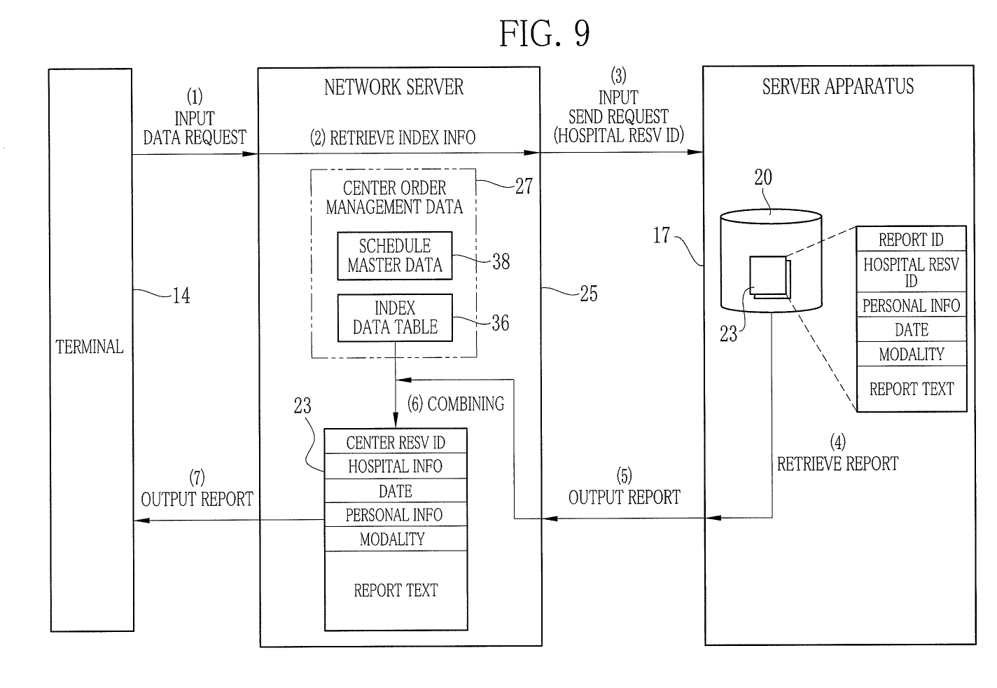

The examination reports 23 are stored in the record database 20 as illustrated in FIG. 9 with a report ID, hospital reservation ID, personal information of a patient, examination date, diagnostic modality and the like. Images (not shown) are stored in the record database 20, for example, in a file format according to the DICOM (Digital Imaging and Communication in Medicine).

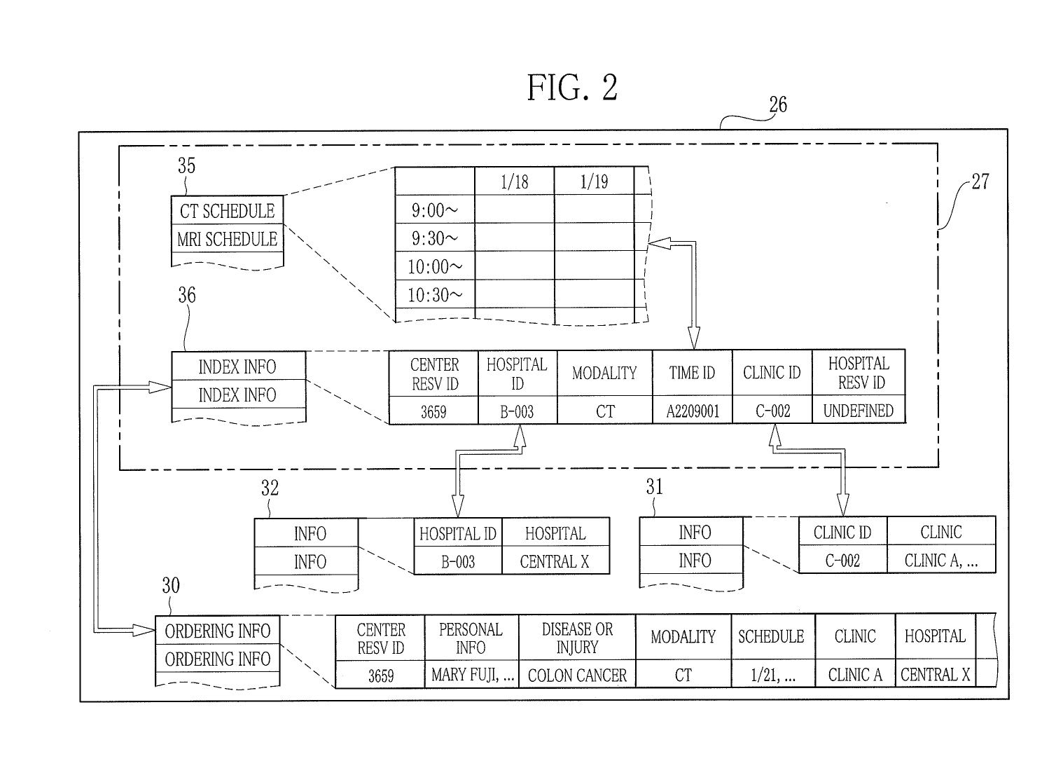

The data center 11 provides a service of receiving an examination order and an order tracking service (reservation confirmation) of retrieval without storing personal information of a patient related to the examination. The data center 11 has the network server 25 and a center database 26 or DB. Center order management data 27 of FIG. 2 are stored in the center database 26 and are information of a current status of the examination order for respectively the central hospital 12.

The use of the center order management data 27 is different from the hospital order management data 21. The region of the center order management data 27 stores index information (See FIG. 2) defined by removal of the personal information of the patient from the ordering information, in place of the ordering information including the personal information. The index information includes partial information for specifying the clinic 13, the central hospital 12 and the ordering information received by the server apparatus 17.

The network server 25 is a web server in compliance with the document system of the World Wide Web (WWW) on the Internet. The network server 25 sends and receives data in response to a request from the terminal device 14.

A virtual private network 29 or VPN connects the server apparatus 17 to the network server 25. The virtual private network 29 operates by utilizing an encryption technique, and establishes a logical communication channel specialized within a network in which plural users are online. This is effective in keeping a secret status between the local areas of the communication, for secure relationship of information in the network.

The network server 25 assigns the ordering information from the terminal device 14 with a center reservation ID (See FIG. 2), and then writes the ordering information to the center database 26 in a temporary manner. The center reservation ID is used to identify the ordering information received by the network server 25, and usable only in the data center 11. The network server 25 transmits the ordering information stored temporarily to the server apparatus 17, and also creates index information from the ordering information. The index information is written additionally to the center order management data 27. See FIG. 2.

The network server 25 specifies the central hospital 12 storing the case specific information related to the data request according to the index information upon receiving the data request for this from the terminal device 14. The network server 25 transmits a send request associated with the data request to the server apparatus 17 in the central hospital 12, and transmits the received case specific information from the server apparatus 17 to the terminal device 14 online. Furthermore, the network server 25 abandons the case specific information received from the server apparatus 17 after the online transmission.

Thus, the network server 25 operates between the terminal device 14 and the server apparatus 17 without storing the case specific information of the examination, such as personal information, in the data center 11.

In FIG. 2, the center database 26 in the data center 11 stores the center order management data 27 and also a reception data table 30 as ordering information, clinic master data 31, and hospital master data 32.

A region of the reception data table 30 temporarily stores ordering information received by the network server 25 from the terminal device 14. The ordering information includes a center reservation ID, personal information of a patient, name of a disease or injury, diagnostic modality, examination date and time, name of the clinic 13, name of the central hospital 12 and the like.

The reception data table 30 is updated by receiving new ordering information from the terminal device 14. Also, the reception data table 30 is updated upon transmission of the stored ordering information to the server apparatus 17. In response to this, the ordering information after the transmission is deleted.

A region of the clinic master data 31 stores a clinic ID, clinic information and the like for each of the clinics 13. A region of the hospital master data 32 stores a hospital ID, hospital information and the like for the respective central hospital 12. The clinic information and hospital information is information of a name, address, telephone number and the like of each of the clinics and hospital.

The center order management data 27 includes schedule master data 35 for reservation and an index data table 36 as index information. A region of the schedule master data 35 stores an examination time ID assigned to each one of table cells, and a date and time zone of the table cell, in a manner classified for the diagnostic modalities which are the CT, MRI and the like. Also, the region of the schedule master data 35 has an area for storing a center reservation ID for respective table cells. The schedule master data 35 has storage regions for storing the center reservation ID for respective table cells. The table cells are time zones respectively having 30 minutes, for example, 9:00, 9:30 and the like. When new ordering information is received from the terminal device 14, the center reservation ID of the ordering information is stored in one time zone in the schedule master data 35 specified by the ordering information.

Management of the schedule master data 35 or the center order management data 27 is synchronized with that of the hospital order management data 21. For example, event information or a flag is written for an unavailable time zone in the schedule master data 35 according to the examination order in the central hospital 12.

A region of the index data table 36 stores index information created by the network server 25. The index information is defined by deleting the personal information and a name of the disease or injury from the ordering information in the reception data table 30 to maintain anonymity, and includes a center reservation ID, hospital ID, diagnostic modality, examination time ID, clinic ID, and hospital reservation ID.

The hospital ID is assigned to the central hospital 12 related to the examination order. The clinic ID is assigned to the relevant one of the clinics 13 as terminal devices.

The hospital reservation ID included in the index information is information assigned by the server apparatus 17 to the ordering information as an origin of the index information, and has been retrieved by the network server 25 from the server apparatus 17.

The hospital reservation ID included in the index information is information for associating the index information with the ordering information received by the server apparatus 17. It is possible to specify the ordering information associated with the index information among datasets of the ordering information stored in the case database 19 according to the hospital reservation ID. In short, the index information is a query or index term for specifying the clinic 13, the central hospital 12, and the ordering information stored in the case database 19.

Sets of the information stored in the clinic master data 31, the hospital master data 32, the schedule master data 35, and the reception data table 30 and the index data table 36 are associated with one another. A second one of those can be found by tracking a first one of them. For example, the hospital information “X central hospital” in the hospital master data 32 can be found by tracking the hospital ID “B003” in the index information.

In FIG. 3, a patient data table 37 is stored in the patient database 18 of the central hospital 12. A region of the patient data table 37 stores a patient ID, personal information, cost information, electronic data of a progress note, and the like for each of patients. The patient ID is usable only in the central hospital 12. The patient data table 37 is updated through an internal terminal device in the central hospital 12 when information of a new patient is input.

The case database 19 stores the hospital order management data 21, the clinic master data 31 and the like. The hospital order management data 21 include schedule master data 38 for reservation and a case data table 39 of reservation. The schedule master data 38 are basically the same as the schedule master data 35 described above.

A region of the case data table 39 stores ordering information received from the network server 25. The ordering information includes a hospital reservation ID, patient ID, diagnostic modality, examination time ID, clinic ID, current status and the like. The current status is information of a progress of the examination. When the examination report 23 or the like is stored in the record database 20, the server apparatus 17 updates the status of the ordering information to change from an “undone” status to a “done” status.

Sets of the information stored in the clinic master data 31, the schedule master data 38, and the patient data table 37 and the case data table 39 are associated with one another. A second one of those can be found by tracking a first one of them. For example, the personal information “Mary Fuji” or a name of a patient in the patient data table 37 can be found by tracking the patient ID “S3-01234” in the ordering information.

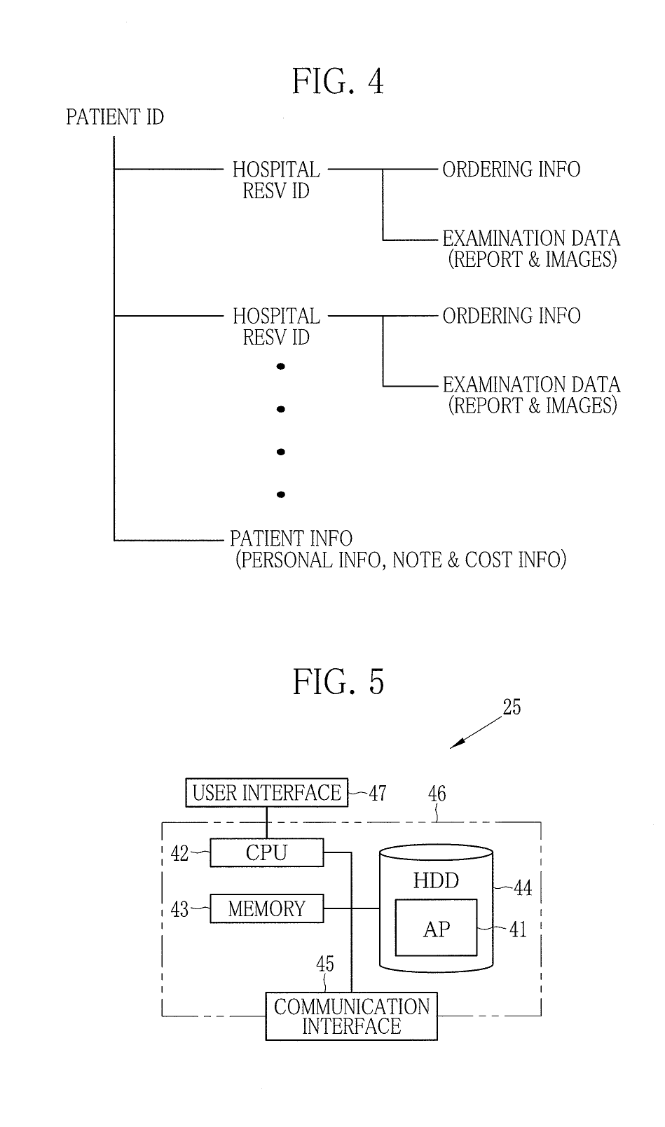

In FIG. 4, the ordering information and examination data of the examination in the central hospital 12 are associated with the hospital reservation ID assigned to the ordering information in addition to the patient ID. One common patient ID is used if plural examinations are made for one patient, or if two or more of the clinics 13 place examination orders in relation to the common patient. However, the examinations are assigned with hospital reservation IDs different from one another. Ordering information and examination data are stored in respectively the case database 19 and the record database 20 with the different hospital reservation IDs.

Although examination data and ordering information according to the data request from the clinic 13 cannot be specified by use of the patient ID, those can be reliably specified by use of the hospital reservation ID specifically when plural examinations are required for one patient, because the hospital reservation ID must be issued for one particular examination. Thus, the index information in the data center 11 in FIG. 2 is associated with the examination data and ordering information in the central hospital 12 by the hospital reservation ID in the index information.

In FIG. 5, each of the terminal devices 14, the server apparatus 17 and the network server 25 is based on a computer which may be a personal computer, server oriented computer, workstation or the like. An application program 41 (AP) and an operating system (OS or control program) are installed in each of the terminal devices 14, the server apparatus 17 and the network server 25.

Each of the terminal devices 14, the server apparatus 17 and the network server 25 includes a computer main unit 46 and a user interface 47 or console. The computer main unit 46 has a CPU 42, a memory 43, a hard disk drive 44 or HDD, and a communication interface 45.

The hard disk drive 44 stores the control program and the application program 41. The memory 43 is a working memory with which the CPU 42 performs tasks. The CPU 42 loads the memory 43 with the control program read from the hard disk drive 44, and controls various operation elements by processing according to the control program.

Examples of the communication interface 45 are a LAN port, WAN port, router and the like, to which a communication cable is connected online with the Internet 15 or the virtual private network 29. The communication interface 45 transmits and receives data with the Internet 15 or the virtual private network 29. The user interface 47 includes an input device such as a mouse, keyboard and the like, and an output device such as a display panel, in a manner well-known in the art. By way of the CPU 42, a first CPU 42a to create index information is included in the network server 25. A second CPU 42b is included in the server apparatus 17.

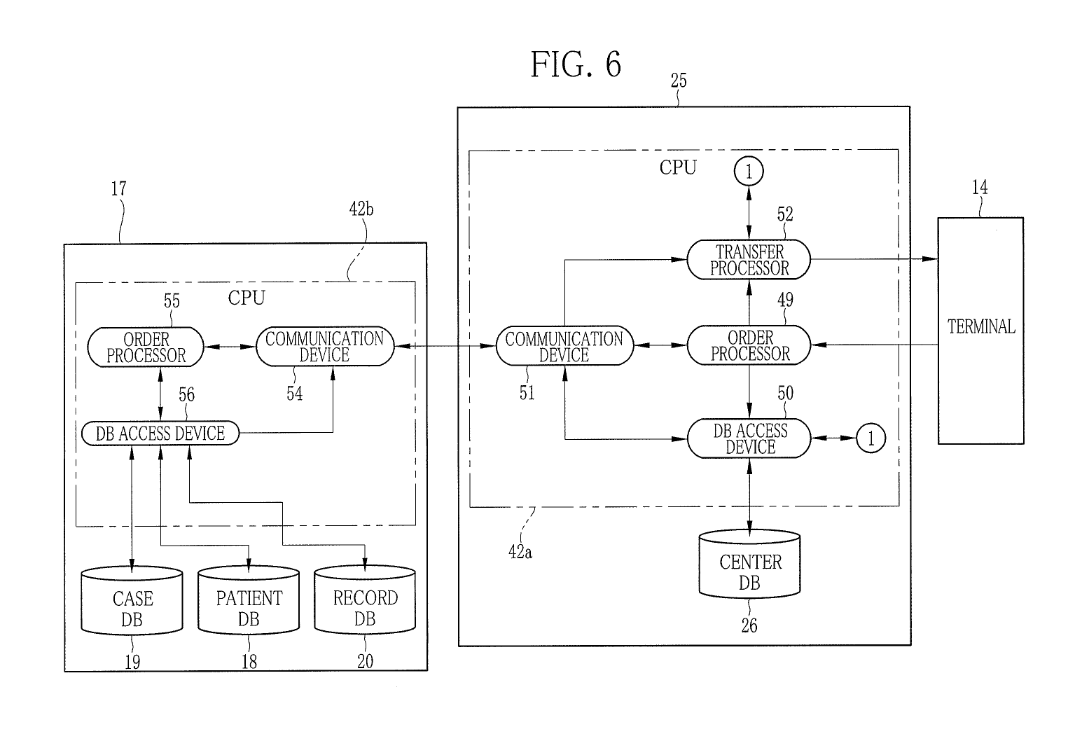

In FIG. 6, the first CPU 42a of the network server 25 loads the application program 41 read from the hard disk drive 44, and operates in a sequence of steps described in the application program 41. Therefore, an order processor 49, a database access device 50 or database interface for writing and reading, and a transfer processor 52 for providing and coupling are established in the first CPU 42a of the network server 25.

The order processor 49 receives the ordering information from the terminal device 14 and a data request of the case specific information of the examination by way of a request processor or a data request receiving unit partially. The database access device 50 accesses the center database 26, and operates for writing, updating and reading data in the center database 26 by way of an index information generating device partially, the data including the ordering information and index information.

A communication device 51 or transmitter/receiver cooperates with the database access device 50 to constitute a request unit for generating a send request. Data are sent to and received from the second CPU 42b or a communication device 54 or transmitter/receiver in the server apparatus 17 by the communication device 51. Examples of data from the communication device 51 to the server apparatus 17 are ordering information, and a data request for an examination order, examination data and the like. Examples of data from the server apparatus 17 to the communication device 51 are a hospital reservation ID (at the time of receiving ordering information from the network server 25), ordering information, examination data and the like.

The transfer processor 52 cooperates with the database access device 50 for providing information and combining. The transfer processor 52 receives the case specific information of the examination from the server apparatus 17 according to the data request from the network server 25, and converts the information into a format for display at the terminal device 14, and transmits the converted information to the terminal device 14.

An order processor 55 and a database access device 56 or database interface are established in the second CPU 42b of the server apparatus 17 as well as the communication device 54 according to the process including steps described in the application program 41. Data are sent to and received from the communication device 51 by the communication device 54. The order processor 55 receives ordering information and a data request from the network server 25 through the communication device 54.

The database access device 56 accesses the patient database 18, the case database 19 and the record database 20, and operates for writing, updating and reading data in those, the data including the ordering information, the patient information and the examination data.

Operation of various elements in the CPUs 42a and 42b for services of receiving an examination order and retrieving information is described now by referring to FIGS. 6, 7 and 8. If a doctor or operator wishes to place an examination order through a node or terminal device in the central hospital 12, the operation is the same as that known in the art. For the order receiving service, only placement of an examination order from the terminal device 14 outside the central hospital 12 is described herein.

[Service of Receiving an Examination Order]

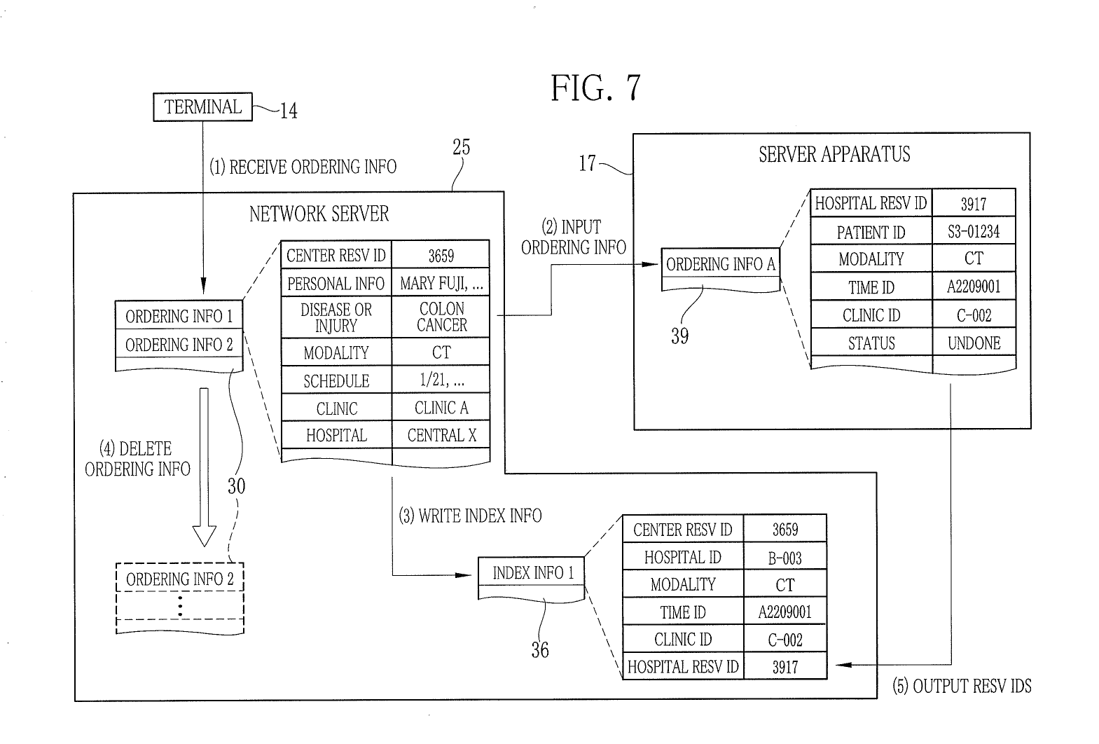

In FIG. 7, a doctor or operator at the terminal device 14 designates an available date and time zone in the central hospital 12, and places an examination order. The order processor 49 in the network server 25 receives the ordering information from the terminal device 14, and inputs the same to the database access device 50. See the direction of the arrow (1). The database access device 50 assigns the ordering information with a center reservation ID, and causes a region of the reception data table 30 temporarily to store the ordering information. Also, the database access device 50 writes the center reservation ID in the date and time zone in the schedule master data 35 in an updated manner.

Then the database access device 50 reads the ordering information from the reception data table 30, and outputs the same to the communication device 51. The communication device 51 transmits the ordering information to the communication device 54 of the server apparatus 17. See the direction of the arrow (2). After this, the database access device 50 creates index information from the ordering information in the reception data table 30 by deletion of its personal information, name of the disease or injury, and the like to maintain anonymity, and writes the index information to the index data table 36. See the direction of the arrow (3). After writing the index information, the ordering information as its origin is deleted from the reception data table 30 by the database access device 50. See the direction of the arrow (4).

The ordering information received by the communication device 54 is input through the order processor 55 to the database access device 56. The database access device 56 additionally assigns the hospital reservation ID and patient ID to the ordering information, and then writes the same to the region of the case data table 39. The patient ID is a newly generated patient ID for a new patient, and is a registered patient ID stored in the patient data table 37 for a repeating patient. At the same time as the writing, the database access device 56 updates the schedule master data 38.

Also, the database access device 56 outputs the hospital reservation ID and the center reservation ID of the ordering information to the communication device 54 upon assigning the ordering information with the hospital reservation ID. The communication device 54 transmits the hospital reservation ID and center reservation ID to the communication device 51 of the network server 25. See the direction of the arrow (5).

The communication device 51 inputs the reservation IDs from the communication device 54 to the database access device 50. At first, the database access device 50 retrieves index information from the index data table 36 according to the center reservation ID. Then the database access device 50 writes the hospital reservation ID additionally with the retrieved index information. Thus, the ordering information of the central hospital 12 is associated with the index information of the data center 11. Finally, the receiving operation of the examination order is completed.

[Service of Order Tracking by Retrieving Case Specific Information of the Examination]

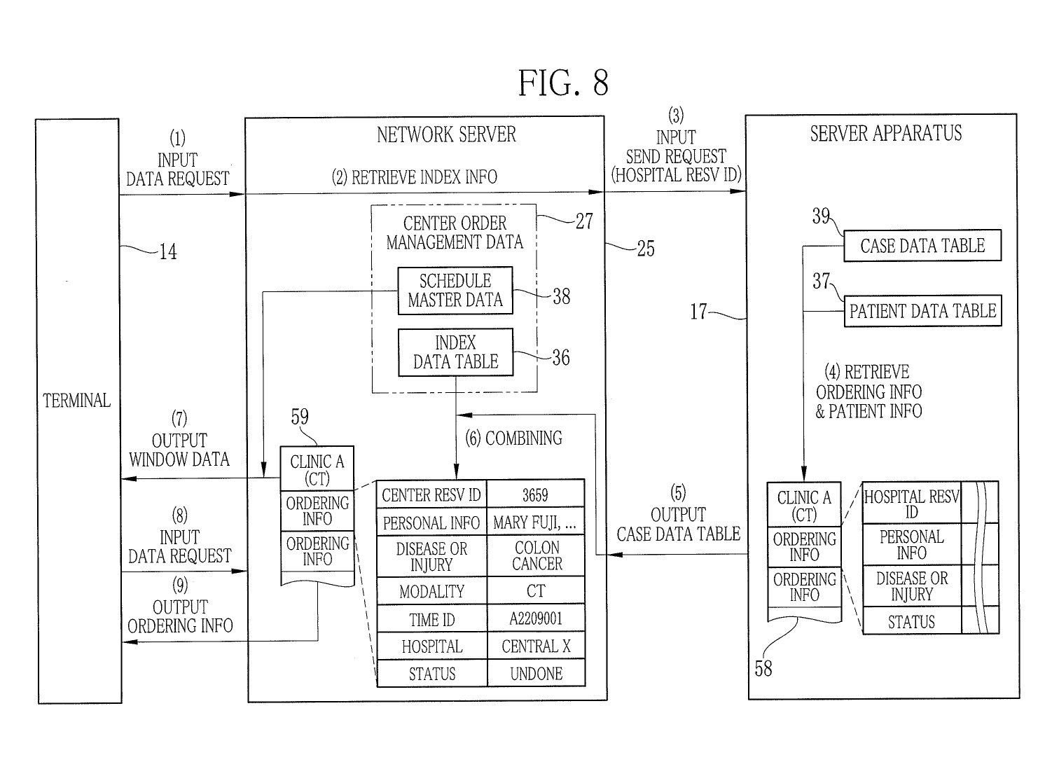

In FIG. 8, let a doctor or operator at the clinic 13 review the content of the examination order and current status after ordering by order tracking (reservation confirmation) in the central hospital 12. To this end, a data request is transmitted from the terminal device 14 to the network server 25. See the direction of the arrow (1). The data request includes information to specify the clinic 13, the central hospital 12, and the diagnostic modality.

The order processor 49 in the network server 25 transmits the data request from the terminal device 14 to the database access device 50. According to the data request, the database access device 50 designates the clinic 13, the central hospital 12, and the diagnostic modality of the examination, and searches and retrieves all the index information in the index data table 36 according to the results of the designation. See the direction of the arrow (2). Then the database access device 50 reads the hospital reservation ID according to the retrieved index information, and transmits the send request inclusive of the hospital reservation ID to the communication device 51. The communication device 51 transmits the send request to the communication device 54 in the server apparatus 17. See the direction of the arrow (3).

The send request received by the communication device 54 is input to the database access device 56 through the order processor 55.

The database access device 56 reads ordering information from the case data table 39 in association with the respective hospital reservation ID included in the send request. Also, the database access device 56 reads the personal information and a name of the disease or injury from the patient data table 37 in association with the patient ID included in the respective ordering information. See the direction of the arrow (4). A local case data table 58 of reservation is created by the database access device 56 according to the ordering information and personal information of the patient read from the patient data table 37 and the case data table 39.

The local case data table 58 is a combination of all ordering information received from the clinic 13 such as clinic A in relation to the diagnostic modality (for example, CT) designated by the data request. Datasets of the ordering information in the local case data table 58 include the hospital reservation ID, personal information, name of a disease or injury, and a current status. The local case data table 58 is transmitted by the database access device 56 through the communication device 54 to the communication device 51 of the network server 25.

The communication device 51 receives the local case data table 58 from the communication device 54 and transmits the same to the transfer processor 52. At first, the transfer processor 52 operates according to the hospital reservation ID included in the ordering information in the local case data table 58, and transmits a send request to the database access device 50 for the index information associated respectively with the ordering information. The database access device 50 searches and retrieves index information in the index data table 36 according to the send request from the transfer processor 52, and sends the retrieved index information to the transfer processor 52.

Then the transfer processor 52 picks up and combines required information from index information in association with ordering information in the local case data table 58. See the direction of the arrow (6). The required information is not included in each set of the ordering information, but included in the index information, and necessary for display at the terminal device 14. Examples of the required information are an examination date and time (or examination time ID), name of the central hospital 12 (or hospital ID), and the like.

Consequently, a case data table 59 of reservation is created by the transfer processor 52 as a result of converting the ordering information in the local case data table 58 into formats for display at the terminal device 14, such as a center reservation ID, personal information, name of a disease or injury, date and time zone of the examination, name of the central hospital 12, current status and the like.

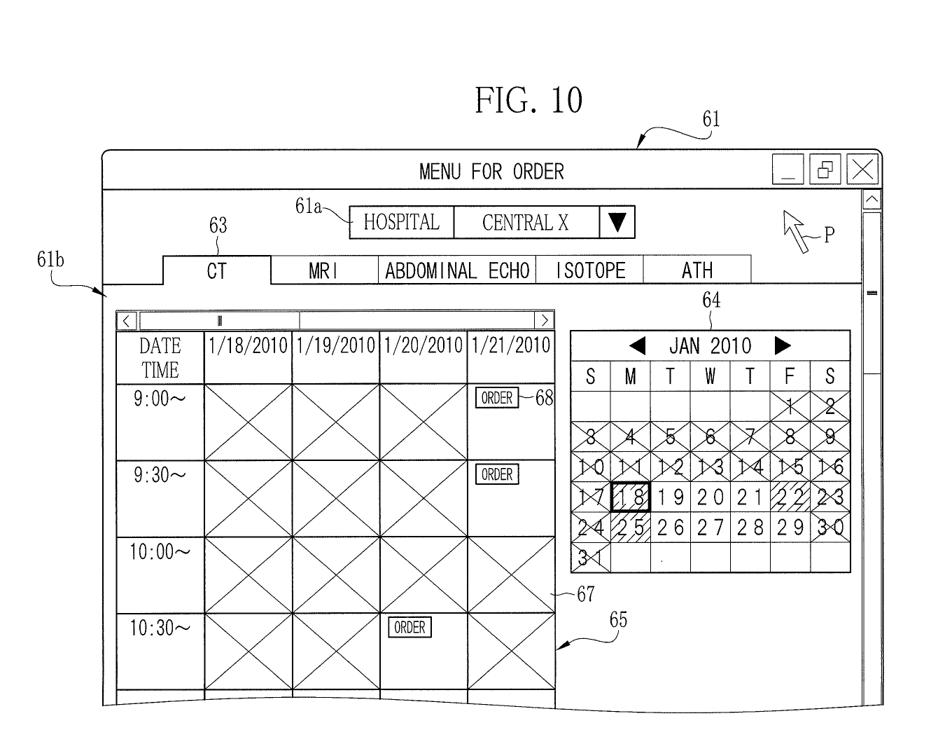

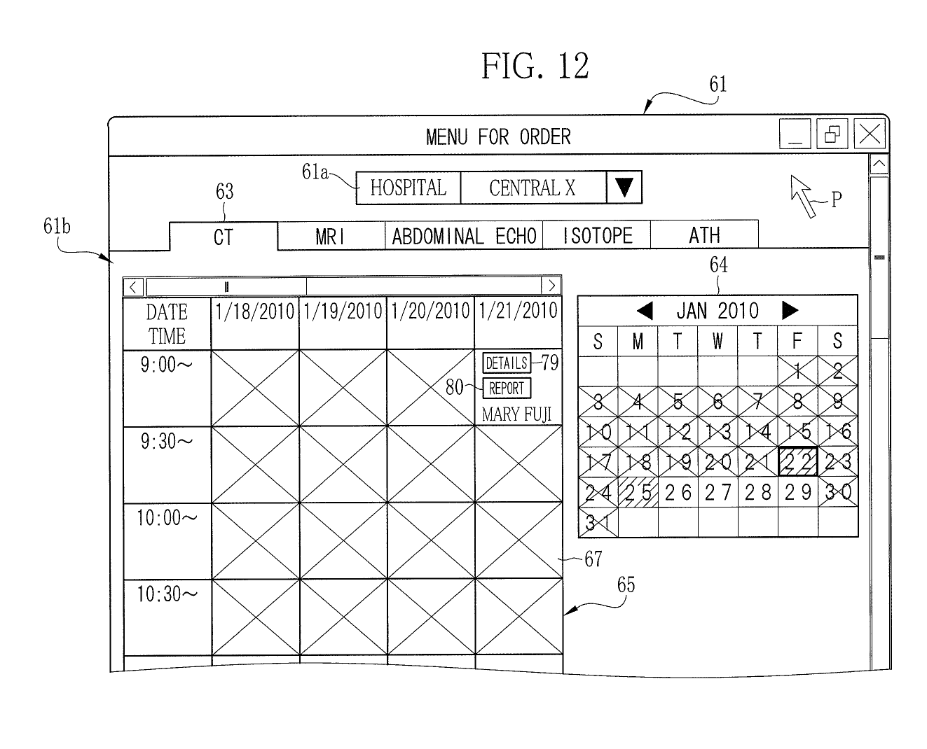

The transfer processor 52 generates window data for an examination date and time and a current status in a calendar form according to the case data table 59 and the schedule master data 38, and transmits the window data to the terminal device 14. See the direction of the arrow (7). This makes it possible at the terminal device 14 by order tracking (reservation confirmation) to review the current status for each one of the diagnostic modalities (CT in FIG. 8) according to ordering in the clinic 13. See FIGS. 10 and 12.

Also, the transfer processor 52 after the transmission of the display window data receives the data request from the terminal device 14 through the order processor 49 in relation to the content of the examination order of the respective examinations having been ordered by the clinic 13. See the direction of the arrow (8). The data request from the terminal device 14 includes query information for searching ordering information in the case data table 59 by the network server 25, for example, the center reservation ID. The transfer processor 52 searches and retrieves the ordering information in the case data table 59 according to the data request, and sends the ordering information to the terminal device 14. See the direction of the arrow (9). This is effective in order tracking of the examination order of the required examination with the terminal device 14.

The transfer processor 52 deletes the case data table 59 including the personal information of the patient upon termination of order tracking of the examination order at the terminal device 14, for example, when the display window for indicating the current status or content of the examination order is closed. Thus, the sequence of the order tracking is terminated.

[Service of Retrieving Examination Data as Case Specific Information of the Examination]

A patient is examined in the central hospital 12. When examination data of the examination is stored in the record database 20, the server apparatus 17 updates the status of relevant ordering information in the case data table 39 from an “undone” status to a “done” status. When the terminal device 14 outputs the data request after updating the status, a status of the ordering information in the case data table 59 becomes a “done” status. It is possible to check the completion of creating the examination data of the examination order having been placed previously by the terminal device 14. See FIG. 12.

Also, it is possible for the network server 25 to transmit a termination message to the terminal device 14 in response to storing the examination data in the record database 20. Specifically, the server apparatus 17 transmits the hospital reservation ID of the examination data to the network server 25 when the examination data becomes stored in the record database 20. The network server 25 retrieves the index information from the index data table 36 in association with the hospital reservation ID, and specifies one of the clinics 13 related to the examination according to the retrieved index information. This is effective in notifying the termination of the examination to the terminal device 14.

In order to retrieve the examination report 23 or examination data in the terminal device 14, the terminal device 14 sends a data request of the examination report 23 to the network server 25 as illustrated in FIGS. 6 and 9. See the direction of the arrow (1). An example of the data request includes a clinic ID of a relevant one of the clinics 13, and a center reservation ID or other key information for the network server 25 to search index information associated with the examination report 23. It is possible to retrieve the center reservation ID from a notification of terminating the examination, or from information of the display window transmitted to the terminal device 14 from the network server 25.

The order processor 49 of the network server 25 inputs the data request to the database access device 50 from the terminal device 14. The database access device 50 searches and retrieves index information from the index data table 36 in association with the center reservation ID included in the data request. See the direction of the arrow (2). Then the database access device 50 creates a send request inclusive of the hospital reservation ID according to the hospital reservation ID of the retrieved index information, and outputs the same to the communication device 51. The communication device 51 transmits the send request to the communication device 54 of the server apparatus 17. See the direction of the arrow (3).

The send request received by the communication device 54 is input through the order processor 55 to the database access device 56. The database access device 56 searches and retrieves the examination report 23 from the record database 20 according to the hospital reservation ID included in the send request, and outputs the examination report 23 being retrieved to the communication device 54. See the direction of the arrow (4). The communication device 54 transmits the examination report 23 to the communication device 51 of the network server 25. See the direction of the arrow (5).

The communication device 51 transmits the examination report 23 to the transfer processor 52. In a manner similar to the event of the data request, the transfer processor 52 retrieves index information from the database access device 50 according to the hospital reservation ID assigned to the examination report 23. Then the transfer processor 52 selectively picks up required information included in the index information, and combines the same with information associated with the examination report 23. See the direction of the arrow (6). Examples of the required information include a center reservation ID, name of the central hospital 12 (hospital ID) and the like. Then the transfer processor 52 converts the examination report 23 into a form suitable for display at the terminal device 14.

Then the transfer processor 52 operates according to the clinic ID included in the report data request from a relevant one of the terminal devices 14, and sends the examination report 23 to the relevant one of the terminal devices 14. See the direction of the arrow (7). When the retrieval of the examination report 23 at the terminal device 14 is terminated, for example, when the report window is closed on the display panel, then the transfer processor 52 deletes the examination report 23. Finally, the retrieval of the examination report is completed.

In FIG. 10, a menu window 61 for an examination order is displayed on a display panel of the terminal device 14. The menu window 61 is generated according to the schedule master data 38 and the case data table 59 by way of the window data. The window data is transmitted online to the terminal device 14 as a text file described by the HTML form, XML form or other markup languages. The browser is installed in each of the terminal devices 14, and forms the menu window 61 according to description of the text file of the window data, to output a signal to the display panel.

The menu window 61 includes a hospital selection area 61a and a status area 61b. The hospital selection area 61a is used for selecting the central hospital 12 where the examination order is placed. The status area 61b is in a calendar form, indicates time zones and a current status of the examination order, and is used for placing the examination order.

For the hospital selection area 61a, a triangular sign at its right end is clicked by the pointer P. Names of the central hospital 12 are indicated in a list form according to a pull down menu for selection in placing an order. For example, the central hospital X is selected. Then a current status of the examination order of the central hospital X is displayed in the status area 61b.

The status area 61b has a form selectively determined for the diagnostic modalities, which include CT, MRI, echo examination of abdominal walls, isotopic examination, and examination of atherosclerosis (ATH). There is a tab 63 for changing over the diagnostic modalities. In FIG. 10, the CT examination is selected.

The status area 61b includes a calendar area 64 or month area and a time table area 65. The calendar area 64 indicates a current status for each one month. The time table area 65 indicates the current status for various time zones in one or more dates. No event information is indicated for an available date in a table cell in the calendar area 64. A sign x is indicated for past dates and holidays. For a date with unavailability for examination, event information is indicated by coloring its table cell in the calendar area 64 with a predetermined color (hatched in the drawing for clarification). Accordingly, available and unavailable dates are distinctly indicated in the calendar area 64 for examination orders.

The pointer P is operated to click a desired date in the calendar area 64. A schedule table 67 for reservation is displayed in the time table area 65 for indicating time zones of a number of dates including the designated date. An order button 68 appears in some of table cells in the schedule table 67 where examination is available with reservation. Event information x is indicated in the schedule table 67 for unavailability.

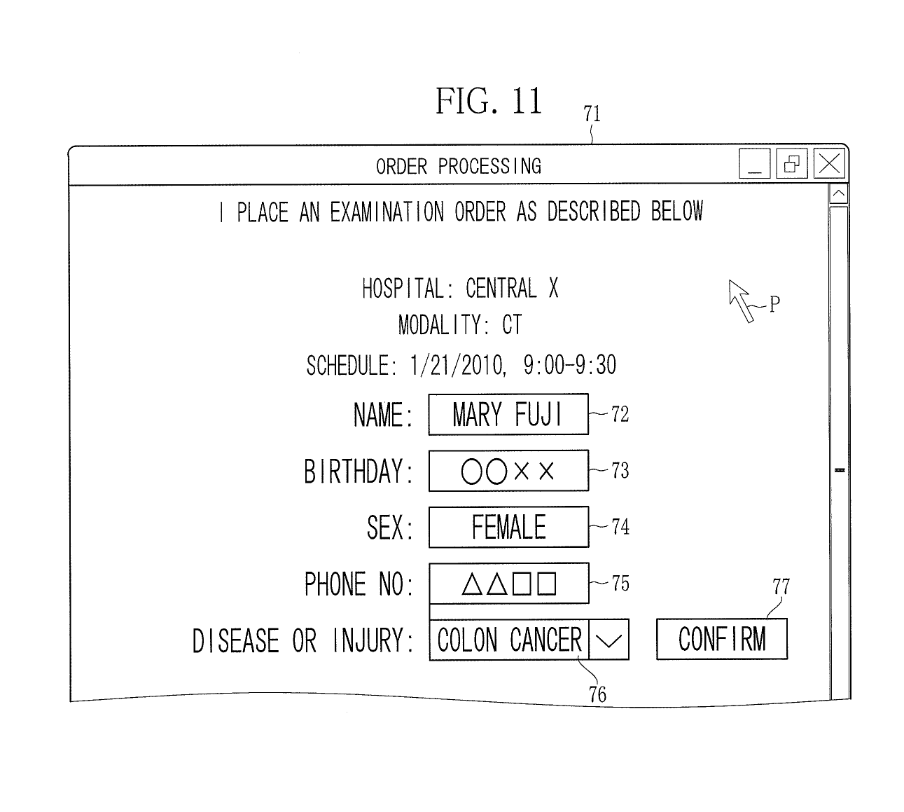

When the order button 68 is clicked, an order window 71 of FIG. 11 for ordering information is displayed on the display panel in place of the menu window 61 for inputting particular items for ordering. The order window 71 indicates the name of the central hospital 12, the diagnostic modality and the time zone of the examination date designated in the menu window 61. Also, various input bars, input fields and buttons are indicated in the order window 71, including a patient's name field 72 as personal information, a birthday field 73, a sex field 74, a residence field 75, a pull down menu 76 and a confirmation button 77. The pull down menu 76 appears for selection of a name of a disease or injury in a registered list. The confirmation button 77 is clicked for confirming the content of the examination order.

When the confirmation button 77 is clicked, a result window (not shown) is caused to appear instead of the order window 71 and displays a successful or unsuccessful status of receiving the examination order. Upon the reception, ordering information according to the content displayed on the order window 71 is transmitted to the network server 25, including the personal information of the patient, disease or injury, diagnostic modality, examination date in the schedule table, name of the clinic 13, name of the central hospital 12 and the like.

When the examination order is received, the patient's name and the like are indicated in the schedule table 67 designated with the order window 71. A details button 79 as data request of FIG. 12 is also indicated for detailed display of the content of the examination order. Also, a report button 80 as data request is indicated in the schedule table 67 if the examination reports 23 of the examination of the same patient have been stored in the record database 20.

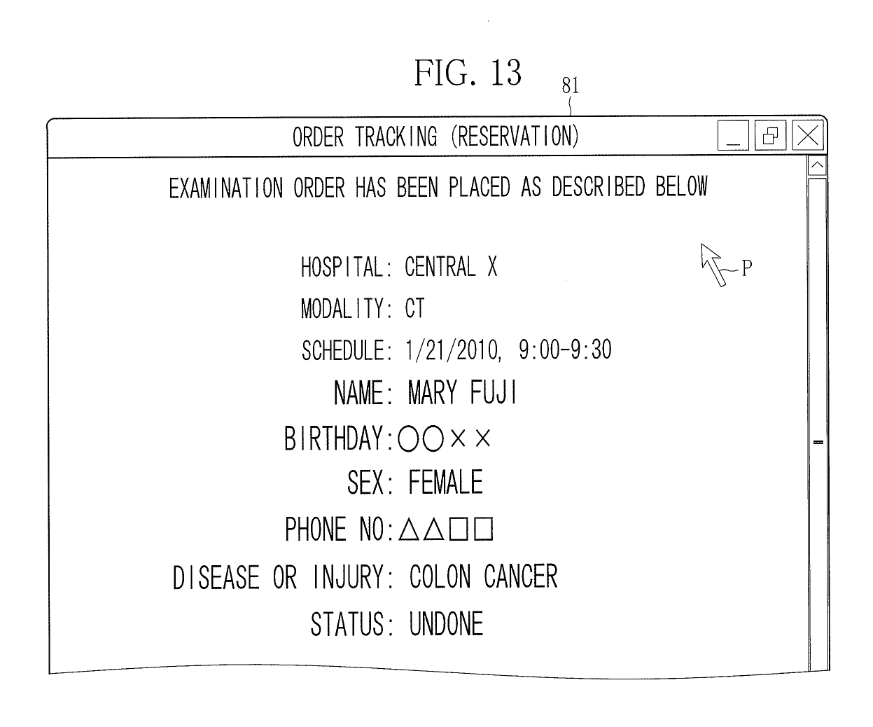

In FIG. 13, an order tracking window 81 is displayed on the display panel by changing over of the menu window 61 when the details button 79 is clicked. Content of the examination order in the order tracking window 81 includes a name of the central hospital 12, diagnostic modality, examination date and time, personal information of the patient, name of a disease or injury, current status, and the like. The order tracking window 81 is created according to data in ordering information within the case data table 59 received by the terminal device 14 from the network server 25.

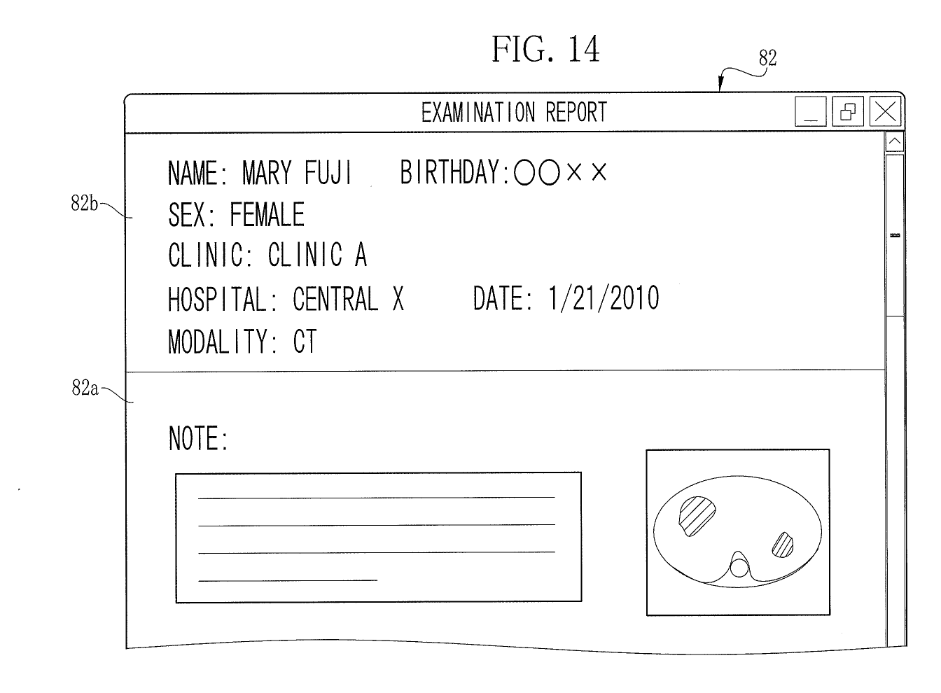

When the report button 80 is clicked in FIG. 14, a report window 82 for an examination report as case specific information is displayed in place of the menu window 61. The report window 82 is created according to the examination report 23 received by the terminal device 14 from the network server 25. The report window 82 includes a note area 82a and a specific data area 82b for metadata. The note area 82a displays findings or progress note in the examination as a text of the examination report 23, and an image in the examination. The specific data area 82b displays various data assigned to the examination report 23, such as personal information, name of the diagnostic service provider, and diagnostic modality.

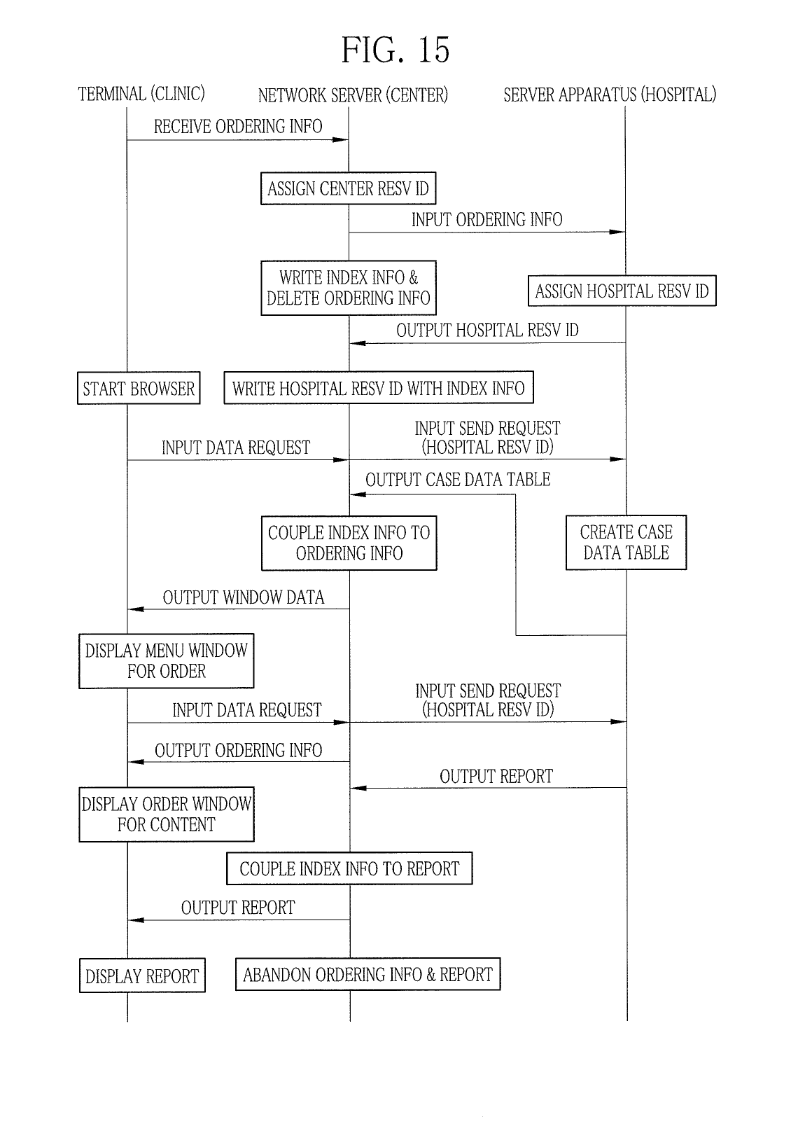

The processing in the network server 25 of the medical network system 10 is described now by referring to FIG. 15, the processing being based on receiving the ordering information from the terminal device 14, and receiving a data request of case specific information of the examination.

[Service of Receiving an Examination Order]

When the terminal device 14 is operated to start up the menu window 61 with the web browser (not shown in FIG. 15), a data request is sent by the terminal device 14 to the network server 25. See the direction of the arrow (1) of FIG. 8. Let the terminal device 14 at a clinic A operate to start up the menu window 61 in FIG. 10. Information of the data request includes the clinic A as a terminal device, the central hospital X as a diagnostic service provider, and the CT as a diagnostic modality.

When the network server 25 receives the data request from the terminal device 14, the CPUs 42a and 42b in the network server 25 and the server apparatus 17 perform the tasks in a sequence in FIG. 8 including searching in the index data table (2), inputting a send request of ordering information (3), retrieval of ordering information and patient information (4), transmission of the local case data table (5), combining information (6), and transmission of window data (7). The display panel displays the menu window 61 of FIG. 10.

When the order button 68 in the menu window 61 is clicked, a display panel displays the order window 71 in FIG. 11 in place of the menu window 61. After all items are input for the examination order with the order window 71, the confirmation button 77 is clicked. Finally, the order is placed with its content input in the order window 71. The ordering information input with the terminal device 14 is transmitted to the network server 25 and stored temporarily in the reception data table 30 in the center database 26. See the direction of the arrow (1) of FIG. 7.

As the region of the reception data table 30 temporarily stores the ordering information, the network server 25 and the CPUs 42a and 42b of the server apparatus 17 perform the tasks described with FIG. 7, which are transmission of the ordering information (2), storing of the index information (3), deletion of the ordering information (4), and transmission of the hospital reservation ID and center reservation ID (5). The region of the index data table 36 in the center database 26 stores the index information defined by deletion of the personal information and the information of the disease or injury from the ordering information. After the storing, the ordering information is deleted from the reception data table 30.

Also, the region of the index information stores the hospital reservation ID assigned by the server apparatus 17 to the ordering information as an origin of the index information. Thus, the ordering information in the central hospital 12 is associated with the index information of the data center 11. No management of ordering information including the personal information is required in the data center 11.

[Service of Order Tracking (Reservation Confirmation) by Retrieving Case Specific Information of the Examination]

After placing the examination order, a doctor or operator operates the terminal device 14 to start up the menu window 61. A data request is transmitted by the terminal device 14 to the network server 25. The steps of the directions of the arrows (2) to (7) are executed, to display the menu window 61 in the display panel at the terminal device 14. In a table cell in the schedule table 67 in the menu window 61 fixed by the examination order from the clinic 13, the details button 79 is indicated. See FIG. 12.

When the details button 79 is clicked, a data request for order tracking of the examination order is input by the terminal device 14 to the network server 25. As described with the directions of the arrows (8) and (9) of FIG. 8, the first CPU 42a in the network server 25 searches and retrieves ordering information from the case data table 59 according to the data request, and transmits the retrieved ordering information to the terminal device 14. Thus, the display panel displays the order tracking window 81 in place of the menu window 61 as illustrated in FIG. 13.

When the menu window 61 appears in response to startup in the terminal device 14, the report button 80 is indicated in the schedule table 67 of the menu window 61 if the examination report 23 of the examination of the examination order has been stored in the record database 20. See FIG. 12.

When the report button 80 is clicked, the terminal device 14 inputs a data request for the examination report 23 to the network server 25. In response to this, the CPUs 42a and 42b in the network server 25 and the server apparatus 17 perform the tasks in a sequence in FIG. 9 including searching in the index data table (2), request of transmission of a report (3), retrieval of the report (4), transmission of the report to the center server (5), combining information (6), and transmission of the report to the terminal device (7). The report window 82 is displayed in place of the menu window 61 at the terminal device 14. See FIG. 14.

When the menu window 61 and the order tracking window 81 are closed at the terminal device 14, the transfer processor 52 abandons the case data table 59 after use. When the report window 82 is closed, the transfer processor 52 abandons the examination report 23. Note that abandonment of the case data table 59 or the examination report 23 may be made after transmission of the same to the terminal device 14. The data center 11 can provide the service of receiving an examination order and the order tracking service of retrieval of information without storing the ordering information, examination data, personal information or the like as case specific information of the examination. It is possible inexpensively to receive an examination order and retrieve information for order tracking, because no large expense is required for managing medical information inclusive of personal information or information discrete for each case.

In the above embodiment, all the ordering information (the local case data table 58) of the examination (for example, CT) sent by the clinic 13 to the central hospital 12 is retrieved by the network server 25 upon startup of the menu window 61 at the terminal device 14. However, only part of the ordering information can be retrieved from the server apparatus 17 in compliance with a doctor's or operator's requirement for order tracking (reservation confirmation).

Specifically, a relevant one of the terminal devices 14 transmits the send request for the center reservation ID to the network server 25 together with the ordering information. The terminal device 14 retrieves the center reservation ID from the network server 25. For order tracking of the examination order of the examination, the retrieved center reservation ID is input by the terminal device 14, to transmit a send request to the network server 25 inclusive of the center reservation ID. Thus, the network server 25 searches and retrieves the index information according to the center reservation ID from the terminal device 14, and retrieves only the ordering information from the server apparatus 17 according to the doctor's requirement of the order tracking. Note that the examination data can be retrieved in the same method.

In the above embodiment, the index information is constituted by the center reservation ID, hospital ID, diagnostic modality, examination time ID, clinic ID, and hospital reservation ID. However, index information according to the invention is not limited, and can be a form for specifying a clinic, diagnostic service provider and ordering information of the examination order.

In the above embodiment, the case specific information of the examination is the ordering information, examination data and the like of the examination. However, case specific information of the examination according to the invention can be any information personally particular to a patient or case of the examination order.

In the above embodiment, the network server 25 combines or couples the case specific information of the examination from the server apparatus 17 with required information included in the index information, and transmits the combined information to the terminal device 14. However, it is possible to transmit the case specific information of the examination from the server apparatus 17 to the terminal device 14 without being combined, specifically if no information required for display at the terminal device 14 is included in the index information.

In the above embodiment, the diagnostic service provider for an examination order is the hospital. However, a diagnostic service provider according to the invention may be a specialized clinic, medical university, laboratory, diagnostic company, service vehicle, or the like.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A network server comprising:
an order processor for receiving ordering information from a terminal device, said ordering information being adapted to placing an examination order of a medical examination and including personal information of a human body, content of said examination order, information of a diagnostic service provider for said examination, and information of said terminal device;
a communication device for transmitting said ordering information received by said order processor to a server apparatus positioned with said diagnostic service provider specified according to said provider information;
an information generating device for creating index information from said ordering information, said index information specifying said terminal device, said diagnostic service provider and said ordering information, wherein said personal information is unrecognizable in said index information for anonymity;
a request processor for receiving a data request from said terminal device for case specific information of said examination of said examination order;
a request unit for transmitting a send request for outputting said case specific information to said server apparatus according to said index information upon receiving said data request in said request processor; and
a transfer processor for transmitting said case specific information output by said server apparatus according to said send request to said terminal device, and deleting said case specific information after transmission thereof.

2. A network server as defined in claim 1, wherein said case specific information, before said examination, is said content of said examination order, and after said examination, is a result of said examination associated with said personal information.

3. A network server as defined in claim 1, further comprising:
a first database; and
a database access device for writing said ordering information from said order processor to said first database in association with a first reservation ID for identifying said ordering information, and deleting said ordering information from said first database after said index information is produced from said ordering information in said first database.

4. A network server as defined in claim 3, wherein said index information further includes said first reservation ID.

5. A network server as defined in claim 3, wherein said communication device additionally assigns said index information with a second reservation ID for identifying said ordering information in said server apparatus upon receiving said second reservation ID from said server apparatus;
said second reservation ID is created by said server apparatus, and stored in a second database of said server apparatus in association with said case specific information.

6. A network server as defined in claim 5, wherein said request unit retrieves said index information from said first database in association with said examination according to said data request, specifies said server apparatus according to said index information, and transmits said second reservation ID to said server apparatus.

7. A network server as defined in claim 6, wherein said transfer processor converts said case specific information in a format for display at said terminal device, and transmits said converted case specific information to said terminal device.

8. A network server as defined in claim 7, wherein said transfer processor further converts at least partial information included in said index information, and transmits said converted partial information to said terminal device.

9. A medical network system comprising:
plural terminal devices, positioned locally, for generating ordering information of an examination order of a medical examination inclusive of personal information of a human body;
a server apparatus, positioned with a diagnostic service provider for said examination, for receiving said ordering information;
a network server connected online with said plural terminal devices and said server apparatus;
said network server including:
an order processor for receiving said ordering information from each one of said terminal devices;
a communication device for transmitting said ordering information received by said order processor to a server apparatus specified according to said provider information;
an information generating device for creating index information from said ordering information, said index information specifying said terminal device, said diagnostic service provider and said ordering information, wherein said personal information is unrecognizable in said index information for anonymity;
a request processor for receiving a data request from said terminal device for case specific information of said examination of said examination order;
a request unit for transmitting a send request for outputting said case specific information to said server apparatus according to said index information upon receiving said data request in said request processor; and
a transfer processor for transmitting said case specific information output by said server apparatus according to said send request to said terminal device, and deleting said case specific information after transmission thereof.

10. A control method for a network server, comprising steps of:
receiving ordering information from a terminal device, said ordering information being adapted to placing an examination order of a medical examination and including personal information of a human body, content of said examination order, information of a diagnostic service provider for said examination, and information of said terminal device;
transmitting said ordering information to a server apparatus positioned with said diagnostic service provider specified according to said provider information;
creating index information from said ordering information, said index information specifying said terminal device, said diagnostic service provider and said ordering information, wherein said personal information is unrecognizable in said index information for anonymity;
when a data request is received from said terminal device for case specific information of said examination of said examination order, transmitting a send request for outputting said case specific information to said server apparatus according to said index information; and
transmitting said case specific information output by said server apparatus according to said send request to said terminal device, and deleting said case specific information after transmission thereof.
